(19) United States
(12) Patent Application Publication
(10) Pub. No.: US 2008/0262680 A1
(43) Pub. Date: Oct. 23, 2008

(54) Apparatus and method for detecting vehicle rollover using an enhanced algorithm having lane departure sensor inputs

(75) Inventors: Huahn-Fern Yeh, Novi, MI (US); Chek-Peng Foo, Ann Arbor, MI (US); Raymond J. David, Dearborn Heights, MI (US); Sonia Gupta, Ann Arbor, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 12/080,353

(22) Filed: Apr. 2, 2008

Related U.S. Application Data
(60) Provisional application No. 60/921,355, filed on Apr. 2, 2007.

(51) Int. Cl. B60R 21/0132

(52) U.S. Cl. 701/45

(57) ABSTRACT

A method is provided including the steps of monitoring a lane departure event, monitoring a rollover event, and controlling actuation of an occupant restraining device in response to the monitored lane departure event and the monitored rollover even.

### CROSS-REFERENCE TO RELATED APPLICATION

The present application is a non-provisional application that claims priority from provisional application Ser. No. 60/921,355 filed in the name of Yeh et al., assigned to the same assignee of the present application, and entitled APPARATUS AND METHOD FOR DETECTING VEHICLE ROLLOVER USING AN ENHANCED ALGORITHM HAVING LANE DEPARTURE SENSOR INPUTS which is hereby fully incorporated herein by reference.

### TECHNICAL FIELD

The present invention relates to an occupant protection system and, more particularly, to an apparatus and method for detecting a vehicle rollover event using an enhanced algorithm having vehicle stability control sensors and lane departure sensors.

### BACKGROUND OF THE INVENTION

To detect a vehicle rollover event, a vehicle may be equipped with one or more sensors that detect vehicle dynamics. The sensors may be connected to a controller that evaluates the sensor signals and controls actuation of one or more actuatable safety devices in response to a determined occurrence of a vehicle rollover event.

U.S. Pat. No. 6,600,414, to Foo et al. discloses an apparatus and method for detecting vehicle rollover event having a discriminating safing function.

U.S. Pat. No. 6,433,681 to Foo et al., discloses an apparatus and method for detecting vehicle rollover event having a roll-rate switched threshold.

### SUMMARY OF THE INVENTION

In accordance with the present invention, an apparatus and method are provided for detecting a vehicle rollover event using an enhanced algorithm having lane departure sensor inputs.

In accordance with one example embodiment, an apparatus is provided comprising a detector for detecting a vehicle rollover event, a lane departure sensor, and a controller responsive to the detector and the lane departure sensor for controlling actuation of an occupant restraining device.

In accordance with another example embodiment, a method is provided comprising the steps of monitoring a lane departure event, monitoring a rollover event, and controlling actuation of an occupant restraining device in response to the monitored lane departure event and the monitored rollover event.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic block diagram of vehicle actuatable control system made in accordance with one example embodiment of the present invention;

FIG. 2 is functional block diagram of a control arrangement in accordance with one example embodiment of the present invention;

FIG. 3 is a flow chart showing a control method in accordance with one example embodiment of the present invention;

FIG. 4 is a schematic diagram of a control logic in accordance with one example embodiment of the present arrangement; and

FIGS. 5-12 are schematic functional block diagrams showing details of the control logic depicted in FIG. 4.

### DESCRIPTION OF AN EXEMPLARY EMBODIMENT

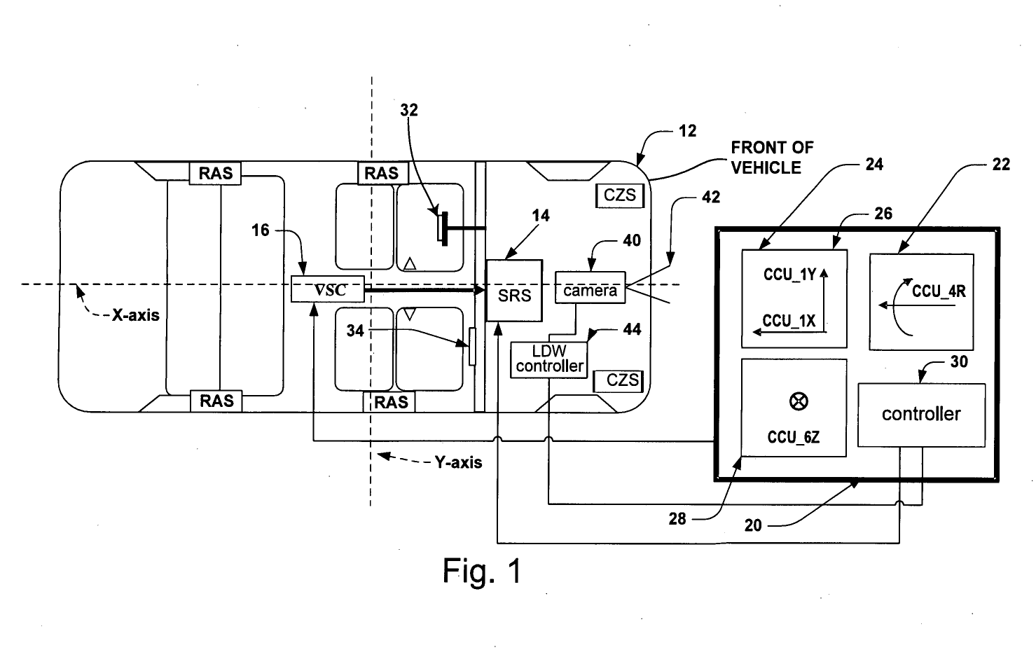

FIG. 1 illustrates an occupant rollover protection system 10 in accordance with the one example embodiment of the present invention. The rollover protection system 10 is mountable in a vehicle 12. The rollover protection system 10 includes two enhanced vehicle safety systems mounted in the vehicle 12, i.e., a supplemental restraint system (“SRS”) 14 and a vehicle stability control (“VSC”) system 16. The SRS 14 includes a sensor assembly 20 having a plurality of sensors including a rollover discrimination sensor 22. The rollover discrimination sensor 22 senses one or more vehicle operating characteristics or conditions that might indicate the occurrence of a vehicle rollover event. The rollover discrimination sensor 22 provides an electrical output signal referred to as CCU_4R having a characteristic functionally related to the sensed vehicle operating characteristic(s) indicative of the vehicle rollover event.

By way of example, the vehicle rollover discrimination sensor 22 is a roll-rate sensor operative to sense angular rotation of the vehicle 12 about a front-to-rear axis, referred to as the vehicle's X-axis. The vehicle rollover discrimination sensor 22 may be mounted at or near a central vehicle location in the vehicle 12 and oriented so as to sense a rate of vehicle rotation about the X-axis of the vehicle 12.

More particularly, the rollover discrimination sensor 22 could be a micro-miniature structure configured to sense angular velocity (e.g., roll-rate) of the vehicle and fabricated using semiconductor manufacturing techniques. When sensing a rate of angular rotation of the sensor in a first direction about its axis of sensitivity, a DC output voltage from the rollover discrimination sensor 22 is positive. Similarly, an angular rate of rotation in the other the direction about the sensor's axis of sensitivity provides a negative sensor output voltage. Thus, when mounted in the vehicle 12, the output signal CCU_4R of rollover discrimination sensor 22 indicates angular velocity of the vehicle, including both magnitude and angular direction, about the sensor's axis of sensitivity. The axis of sensitivity of the rollover discrimination sensor 22 is coaxial with the front-to-rear X-axis of the vehicle 12 through the center of the vehicle. Those skilled in the art will appreciate that the angular velocity about the vehicle's front-to-rear X-axis is the same as its roll-rate or rate of rotation of the vehicle 12.

Also, the sensor assembly 20 further includes a Y-axis acceleration sensor 24 that senses acceleration of the vehicle in the vehicle's sideways direction (perpendicular to the front-to-rear X-axis direction) or along an axis referred to as the Y-axis of the vehicle 12. The Y-axis acceleration sensor 24 outputs an electrical signal referred to as CCU_1Y having an electrical characteristic functionally related to the crash acceleration of the vehicle in the Y-axis direction. The sensor assembly 20 further includes an X-axis acceleration sensor 26 that senses acceleration of the vehicle in the vehicle's front-to-rear direction or along the X-axis of the vehicle. The X-axis acceleration sensor 26 outputs an electrical signal referred to as CCU_1X having an electrical characteristic functionally related to the crash acceleration of the vehicle in the X-axis direction.

The sensor assembly 20 also includes a Z-axis acceleration sensor 28 that senses acceleration of the vehicle 12 in the vehicle's up-and-down direction or in the Z-axis of the vehicle. The Z-axis acceleration sensor 28 outputs an electrical signal referred to as CCU_6Z having an electrical characteristic indicative of crash acceleration of the vehicle in the Z-axis direction.

The SSR system 14 includes a controller 30 that is connected to and monitors all sensor signals from the sensor assembly 20, i.e., CCU_4R, CCU_1Y, and CCU_6Z, and controls appropriate actuatable restraining devices such as front driver and passenger airbags 32, 34, side air curtains (not shown), seat belt pretensioners (not shown), etc. that are useful in attempting to aid in protection of an occupant during a rollover event in response to these signals plus in response to additional signals as described below.

The controller 30, for example, is a microcomputer programmed to perform the operations or functions in accordance with an example embodiment of the present invention. Such functions alternatively could be performed with discrete circuitry, analog circuitry, a combination of analog and discrete components, and/or an application specific integrated circuit.

The VSC 16 is operatively connected to the SRS system 14 to provide other inputs that could be further used to enhance the detection of a vehicle rollover condition and therefore, make the control of the restraining system in response to a rollover condition more robust. The VSC system 16 is of the type that senses other vehicle operating parameters and output signals indicative of those sensed parameters to the SRS 14 such as a vehicle velocity signal, vehicle lateral acceleration signal a_{y}, steer angle signal δ, vehicle yaw rate signal ω_{z}, and vehicle side slip angle signal β. Also, the VSC 16 can detect and determine lateral force induced rollover events, such as encountered during a double lane change, a J-turn, etc, and those involved in transient corning maneuvers that excite the vehicle roll mode. Also, the VSC monitors vehicle lateral acceleration a_{y} and steering angle δ that can be used to improve the robustness of rollover detection. Yaw instability induced rollover events as may occur in soil-trip, and curb-trip events that involve the saturation of tire forces that brings the vehicle into uncontrollable sliding can be determined by the VSC. In this type of event, vehicle yaw rate ω_{z} and side slip angle β can be used to improve the robustness of rollover detection. Steer angle δ and vehicle yaw rate ω_{Z} from the VSC can also be used to improve the robustness of embankment logic.

In accordance with the present invention, robustness of the rollover protection system is increased by using a vehicle's lane departure warning system to determine (1) a lane departure event and (2) rollover using the lane departure vision system. In accordance with one example embodiment of the present invention, a camera 40 of a lane departure warning (“LDW”) system is mounted in the vehicle 12 such as on the inside of the passenger cabin of the vehicle in front of the rear-view mirror (not shown) so as to have a field a view 42 forward-looking of the vehicle 12. The camera 40 can take any of several forms such as CCD, or any other camera type. The camera 40 is slightly angled downward so as to monitor lane markers on a road surface and road edges but still monitors the horizon. The camera 40 is connected to a LDW controller 44 or could be directly connected to the controller 30 of the SRS 14. If the camera 40 is connected to an LDW controller 44, then the LDW controller 44 is connected to controller 30 to provide lane departure and rollover information to controller 30.

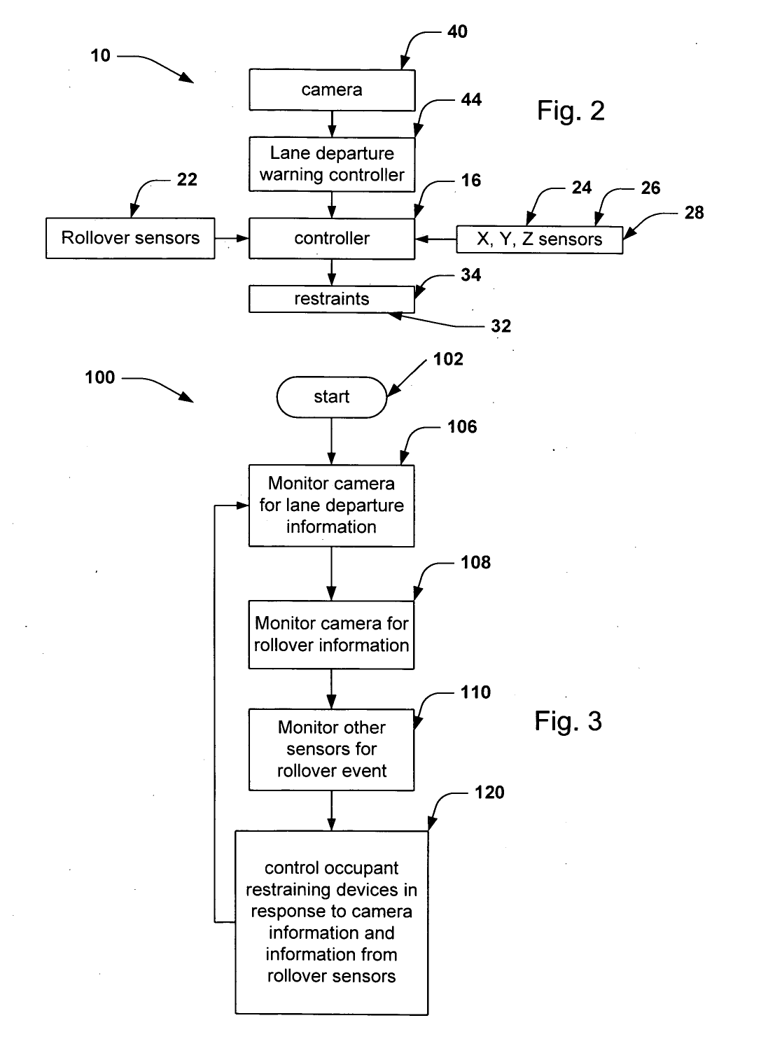

Referring to FIG. 2, a block diagram shows the connection between the camera 40, the lane departure warning controller 44, and the controller 30. Also shown are the connection of the sensors 22, 24, 26, and 28 to the controller 30 and finally the output control connection of the controller 30 to the restraining devices 32, 34 via the SRS.

Referring to FIG. 3, a control process 100 is shown in accordance with an example embodiment of the present invention in which the output of the camera 40 is monitored for lane departure information in step 106. In step 108, the camera 40 is further monitored for vehicle rollover information. In step 110, the other sensors 22, 24, 26, and 28 are monitored for a rollover event. In step 120, the controller 30 makes a determination based on the camera lane departure information in step 106, the camera rollover information in step 108, and the monitored sensor rollover event information in step 110 as to whether the actuatable restraining devices should be actuated. The process then returns to step 106 and continues in the loop.

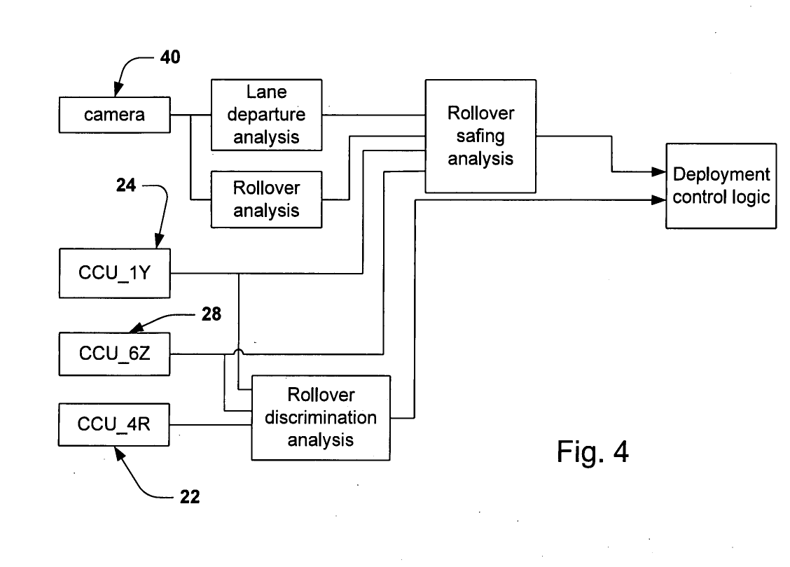

Referring to FIG. 4, a schematic block diagram is shown of the control logic in accordance with an example embodiment of the present invention is shown. The camera 40 of the lane departure warning system is monitored for both a lane departure event using lane departure analysis logic of the controller (either using controller 44 or controller 30) and for a rollover event using rollover analysis logic (either using controller 44 or controller 30). The CCU_1Y and CCU_6Z signals are processed along with the camera lane departure and camera rollover analysis data to establish a rollover safing function, either a digital HIGH or digital LOW condition. The CCU_1Y, CCU_6Z, and CCU_4R data is process using rollover discrimination analysis logic of controller 30 to achieve a discrimination deployment digital HIGH value or digital LOW value. Both the safing and discrimination values are then further process in the deployment control logic section of the controller 30 to control the actuatable restraining devices.

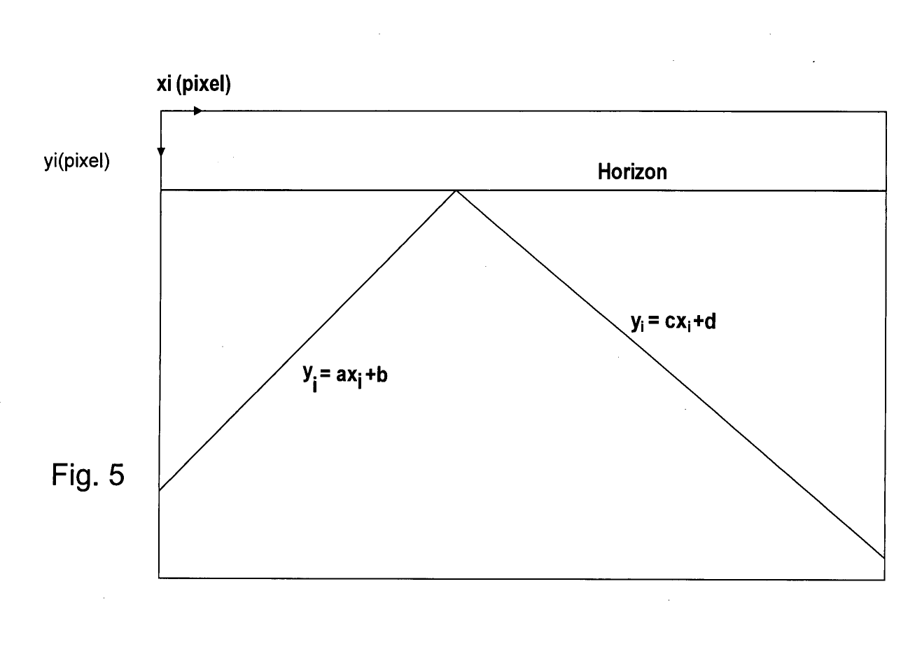

Referring to FIG. 5, an example view of a camera screen of a road is shown. For initial estimation, the estimation of vehicle roll angle using the coefficients of a, b, c, and d estimated by recursive least square method yields a roll angle determined by the half of summation of the slopes of the left and right lane so that:

Φₛₜ=[(a+c)/2](180/π)

The horizon is calculated by the y coordinate of the interception of the left and right lane markers determined by:

Hₛₜ=(bc−ad)/(c−a)

The yaw angle is calculated by:

$${ψ}_{st} = \frac{( \frac{VIDEO\_COLS}{2} - {x}_{cen} ) * PixelWidth}{1000 f} \frac{180}{π}$$

The horizon and pitch angle is calculated by:

Δθ=tan⁻¹(ΔH/f)

where:

x_{cen}=coordinate of the interception of the left lane marker and the right lane marker,

VIDEO_COLS is the number of columns of the screen,

PixelWidth is the width of the pixel,

Yaw angle is the deviation from the center of the screen divided by the focal length.

In accordance with an example embodiment of the present invention, an inverse perspective transformation transforms the screen coordinate to the real road coordinate:

z=f(xi,yi,H,Φ) (1)

x=g(xi,yi,H,Φ) (2)

where

xᵢ=x-coordinate of the screen

yᵢ=y-coordinate of the screen

z=longitudinal coordinate of the real road coordinate

xᵢ=lateral coordinate of the real road coordinate

H=horizon

Φ=camera roll angle

For accurate estimation, the spatial road model

x=c₁+c₂z+c₃z² (3)

Substituting Equations (1) and (2) into (3) yields:

x+Δx=c₁+c₂z+c₃x²+ΔΦy(c₁,c₂,x,z)+ΔHs(c_{c},c₂,x,z) (4)

Equation (4) is used to estimate the change of horizon ΔH and the change of roll angle ΔΦ.

The iteration of the algorithm is described as follows:

(1) The image points are converted to road coordinate system by Eqs. 1 and 2.

(2) The offset c₁, heading angle c₂, curvature c₃, change of horizon ΔH, and the change of roll angle ΔΦ are obtained by Eq. 4 through the recursive least square method.

(3) The new horizon and roll angle are updated by:

H(k)=H(k−1)+ΔH/10

Φ(k)=Φ(k−1)+ΔΦ/10

(4) if ΔH and ΔΦ are less then 10e−5, then stop, else go to step (1).

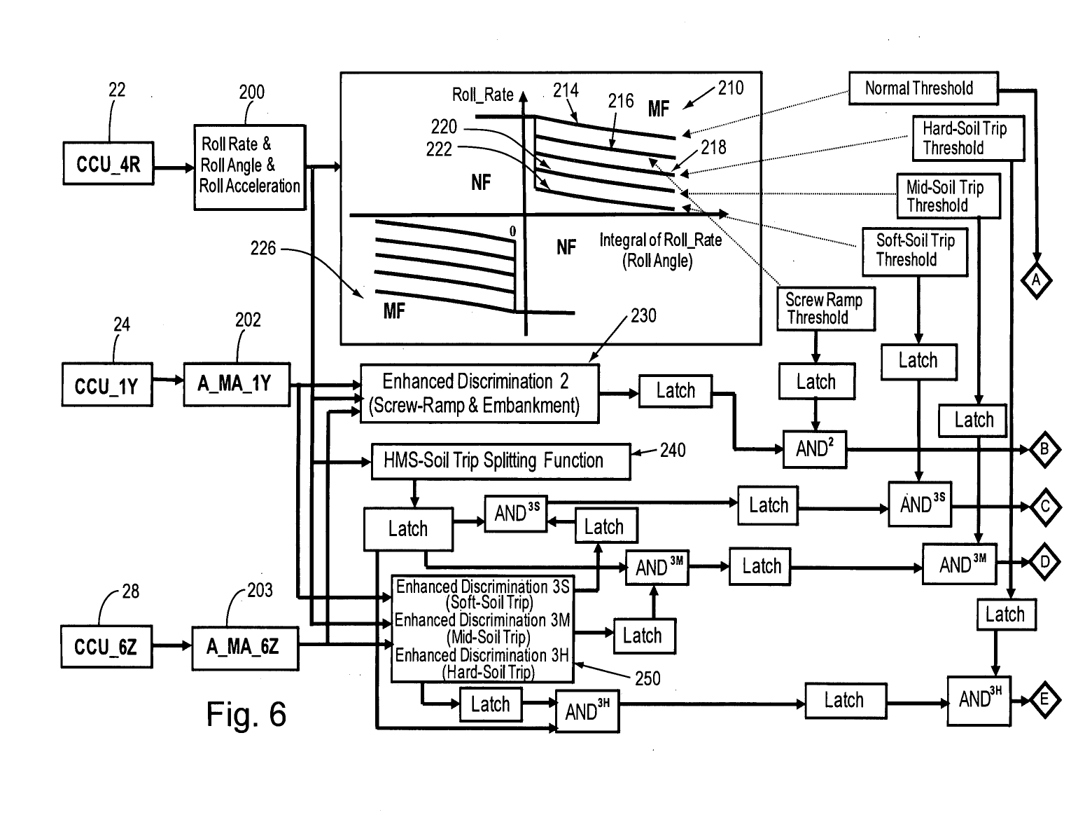

Referring to FIGS. 6-12, the control process shown in FIGS. 3 and 4 will be better appreciated. The roll rate sensor signal CCU_4R from the roll rate sensor 22, is connected a roll rate, roll angle (integral of roll rate), and roll acceleration determining function 200 within the controller 30. The CCU_1Y signal from the Y accelerometer 24 is connected to a moving-average determining function 202 of controller 30 that sums a predetermined number of sampled acceleration signals to determine a moving average value A_MA_1Y value of the side ways acceleration sensed by sensor 24. The CCU_6Z signal from the Z accelerometer 28 is connected to a moving-average determining function 204 of controller 30 that sums a predetermined number of sampled acceleration signals to determine a moving average value A_MA_6Z value of the acceleration sensed in the Z-axis by sensor 28.

A plurality of predetermined threshold values 210 are defined by roll rate values as a function of roll angle values. These thresholds 210 are depicted in graph 212 of FIG. 6. A highest level threshold 214 is said to be a normal threshold value that decreases slightly as roll rate increases. A screw ramp threshold 216 is a first threshold level below the normal threshold level. A second threshold 218 level is two steps below normal for a hard-soil condition. A third threshold level 220 is below the first two representing a mid-soil threshold. Finally, a soft-soil threshold 222 is the lowest threshold available in this control scheme in accordance with one exemplary embodiment of the preset invention. The upper right quadrant 224 represents a rollover in one direction and the lower left quadrant 226 in a rollover in the other direction. If a value of roll rate as a function roll angle exceeds its associated threshold, the “A” value goes to a digital HIGH. If the other associated threshold values are exceeded for hard soil, mid soil, soft soil and a screw ramp, that condition is latched HIGH.

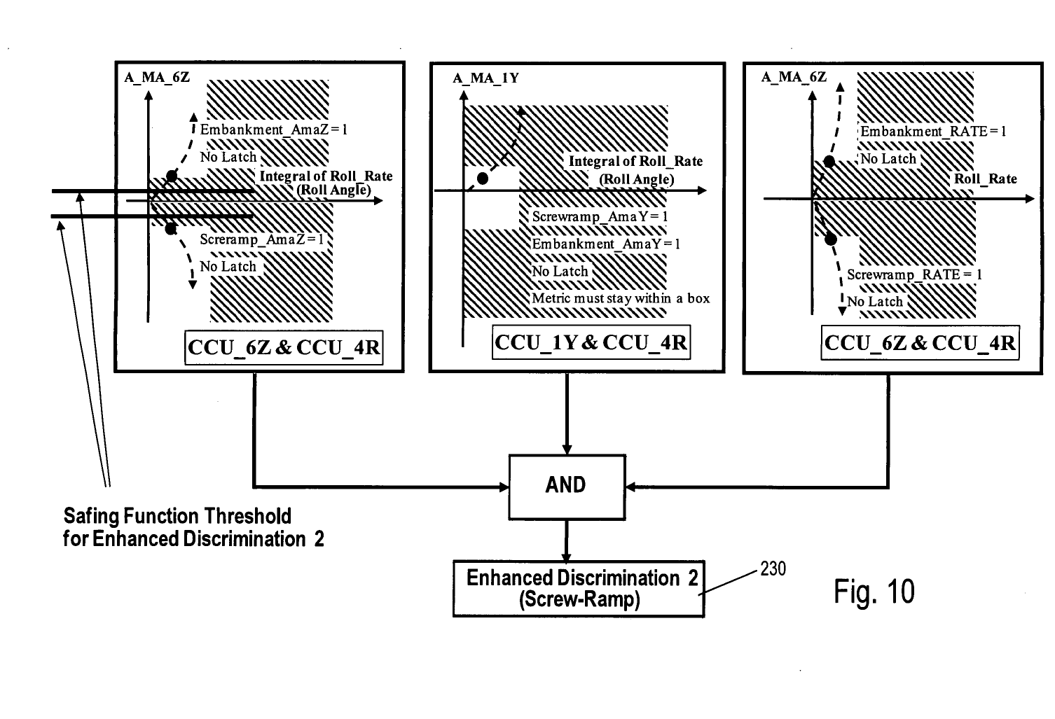

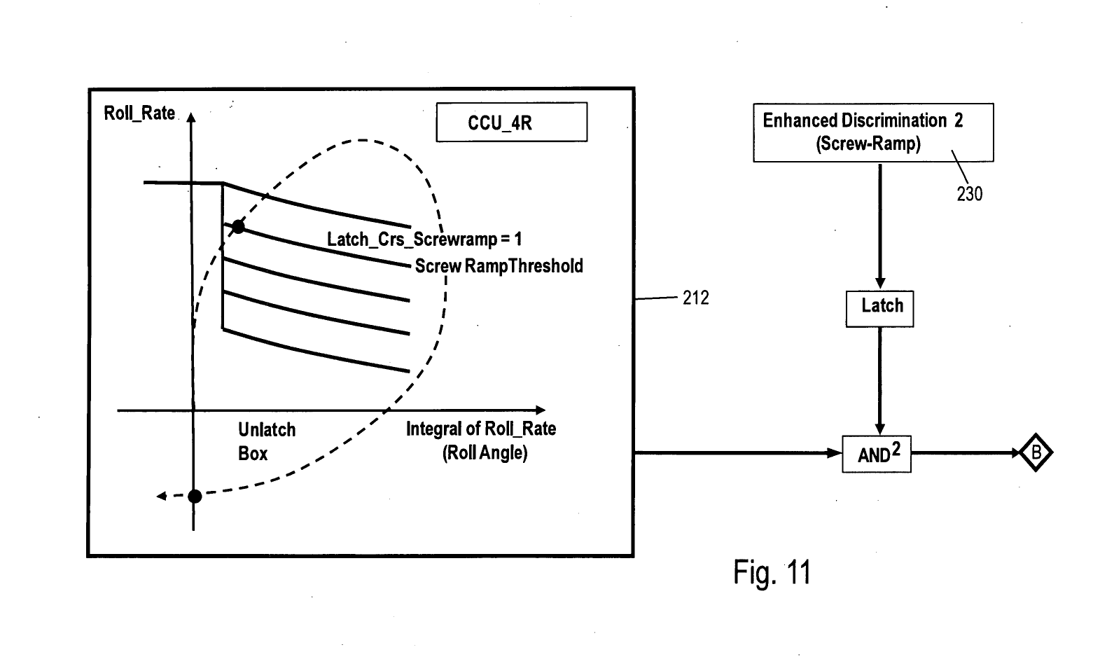

CCU_1Y 28 has a moving average determined in 200 and a moving average of CCU_6Z 24 is determined in 202. Next, a determination is made in function 230 whether a screw ramp or embankment condition is determined based on the moving average values of CCU_4R, CCU_1Y and CCU_6Z. How this is down is best appreciated from FIGS. 10 and 11. If the conditions in FIG. 10 or if the conditions in FIG. 11 are satisfied (metric must stay within the un-shaded boxes) then 230 will be HIGH. If 230 is HIGH, the condition will latch. Both the condition from 212 and 230 must be HIGH for “B” to be HIGH. The final condition need for “B” to be HIGH is shown in FIG. 11.

Next, a determination is made in function 240 whether a HMS-soil trip splitting function is determined based on the moving average values of CCU_4R. When 240 is HIGH, the condition will latch and “C” will be HIGH.

Next, a determination is made in function 250 whether three separate conditions are satisfied or true. All three are determined based on the moving average values of CCU_4R, CCU_1Y and CCU_6Z. First monitors for an enhanced discrimination 3S for a soft-soil trip condition. Next monitors for an enhanced discrimination 3M for a mid-soil trip condition. Next, monitors for an enhanced discrimination 3H for a hard-soil trip condition. The three monitored conditions all have to be true or HIGH.

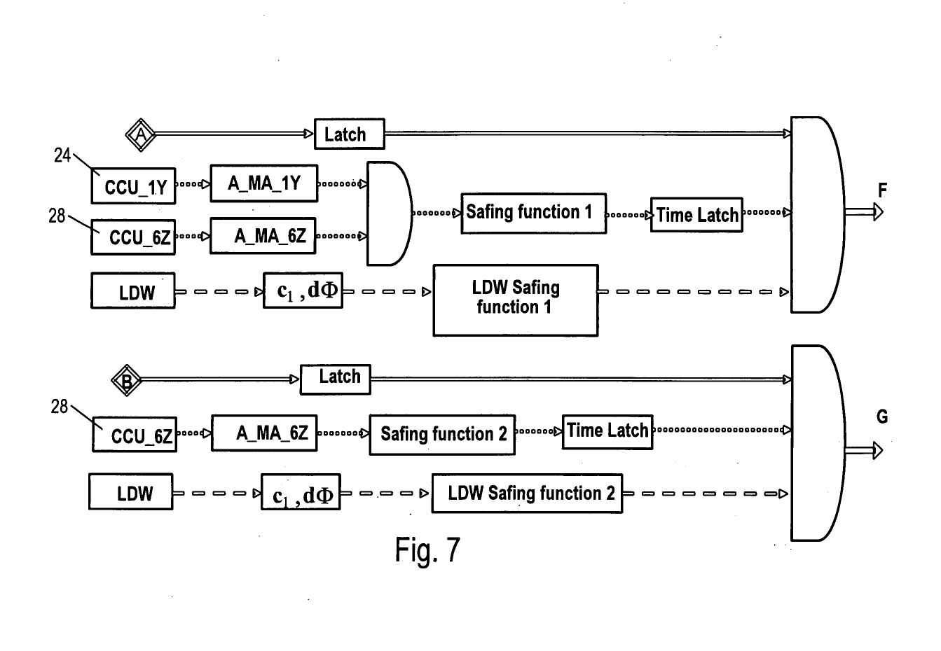

Referring to FIGS. 7-8 and 12, the enhanced inputs from the electronic stability control system combined with the rollover system and the lane change departure warning system will be appreciated.

Referring to FIG. 7, the moving averages of CCU_1Y and CCU_6Z are compared against associated thresholds and are ANDed as a safing function, and also the camera measured values compared against associated thresholds. Both safing functions determined from the camera values and the sensor assembly 20 are ANDed with the “A” condition that is being used as a discrimination function, i.e., A=HIGH being a deployment condition. This arrangement increases the robustness of the system. If all of these conditions are true, then F will be HIGH.

Further referring to FIG. 7, the moving average of CCU_6Z is compared against an associated threshold and the camera values compared against associated thresholds are both ANDed as a safing functions with the “B” condition being used as a discrimination function, i.e., B=HIGH being a deployment condition. If all of these conditions are true, then G will be HIGH.

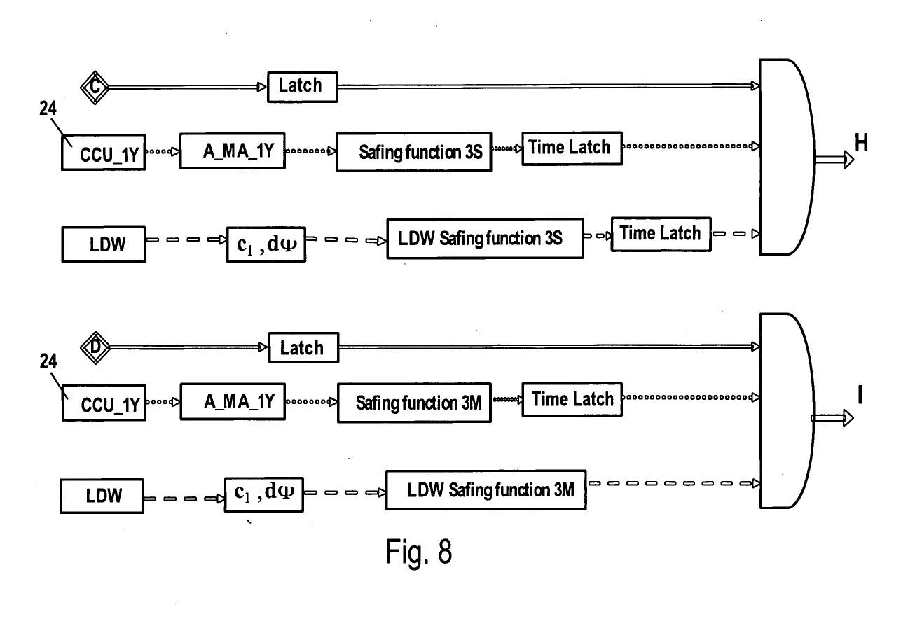

Referring to FIG. 8, the moving average of CCU_1Y is compared against an associated threshold and the camera values compared against associated thresholds and both of these values are ANDed as a safing functions with the “C” condition being used as a discrimination function, i.e., C=HIGH being a deployment condition. If all of these conditions are true, then H will be HIGH.

Further referring to FIG. 8, the moving average of CCU_1Y is compared against an associated threshold and the camera values compared against associated thresholds and both are ANDed as a safing functions with the “D” condition being used as a discrimination function, i.e., D=HIGH being a deployment condition. If all of these conditions are true, then I will be HIGH.

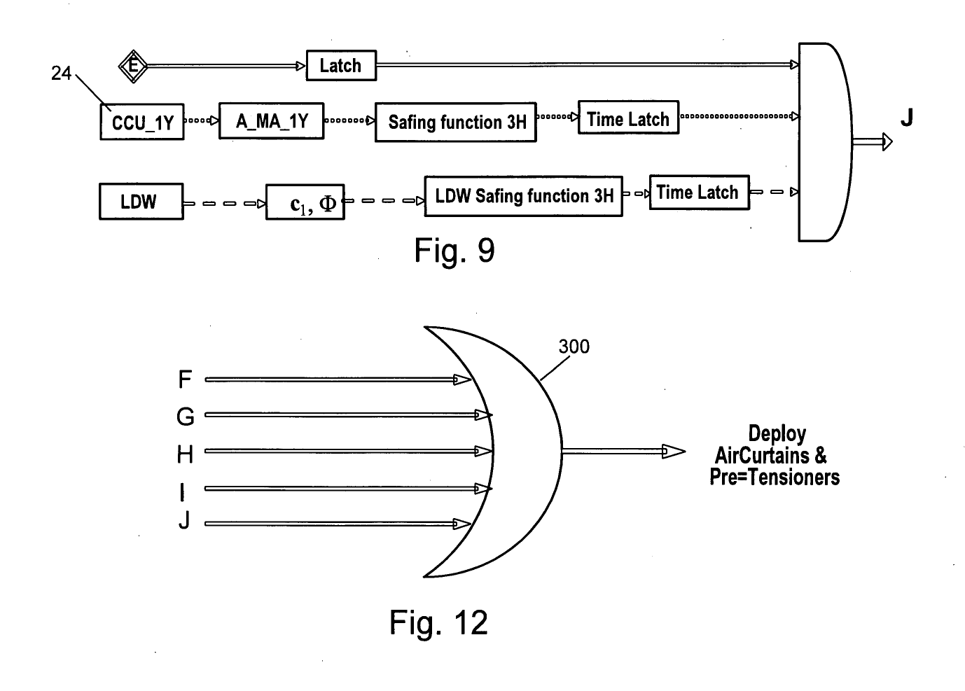

Referring to FIG. 9, the moving average of CCU_1Y is compared against an associated threshold and the camera values compared against associated thresholds and both are ANDed as a safing function with the “E” condition being used as a discrimination function, i.e., E=HIGH being a deployment condition. If all of these conditions are true, then J will be HIGH.

Referring to FIG. 12, the final deployment control logic is shown in which F, G, H, I, and J are connected to OR function 300. If any of the outputs F-J are HIGH, the actuatable restraints in the vehicle 12 will be activated. Those skilled in the art will appreciate that not all restraints need be actuated at once but that a single actuation is shown only as a simple example. The present invention contemplates actuations of multiple devices at different times during the crash event using mapping techniques previous developed by the inventors.

The teachings of U.S. Pat. No. 6,433,681, and U.S. Pat. No. 6,600,414 and U.S. Pat. No. 6,439,007, and U.S. Pat. No. 6,186,539 and U.S. Pat. No. 6,018,693 and U.S. Pat. No. 5,935,182 are all hereby incorporated herein by reference.

The system of the present invention increases the robustness of the rollover detection algorithm for both on-the-road and off-the-road rollover events by using the lane departure warning system. The increase in the robustness of the rollover detection algorithm occurs by detecting the vehicle position relative to the road marker (c₁). This improves the off handling for what would otherwise be rollover events such as curb trips, soil trips, embankments, and screw ramp events. An increase of the robustness of the rollover detection algorithm also occurs by detecting the vehicle roll angle by the spatial road model estimator (Φ). This will improve the on-the-road rollover events such as a maneuver induced rollover event.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for a vehicle comprising:
detector for detecting a vehicle rollover event;
a lane departure sensor; and
a controller responsive to the detector and the lane departure sensor for controlling actuation of an occupant restraining device.

2. The apparatus of claim 1 wherein said detector includes,
vehicle rollover sensor having an axis of sensitivity about the vehicle's front-to-rear axis,
a vehicle lateral sensor for sensor having an axis of sensitivity substantially perpendicular to the vehicle's front-to-rear axis, and
a vehicle up and down sensor having an axis of sensitivity substantially vertical to the vehicle's front-to-rear axis.

3. The apparatus of claim 1 wherein said lane departure sensor includes,
a camera positioned to monitor forward of a direction of travel of the vehicle, and
said controller processing an output of said camera for determining lane information and rollover information.

4. The apparatus of claim 1 wherein said detector includes,
vehicle rollover sensor having an axis of sensitivity about the vehicle's front-to-rear axis,
a vehicle lateral sensor for sensor having an axis of sensitivity substantially perpendicular to the vehicle's front-to-rear axis, and
a vehicle up and down sensor having an axis of sensitivity substantially vertical to the vehicle's front-to-rear axis, and
wherein said lane departure sensor includes,
a camera positioned to monitor forward of a direction of travel of the vehicle, and
said controller processing an output of said camera for determining lane information and rollover information and processing outputs from said rollover sensor, said lateral sensor, and said up and down sensor for control of said actuation of an occupant restraining device.

5. A method comprising the steps of:
monitoring a lane departure event;
monitoring a rollover event; and
controlling actuation of an occupant restraining device in response to the monitored lane departure event and the monitored rollover event.

6. A method for controlling actuatable restraining devices in a vehicle comprising the steps of:
monitoring a lane departure events of the vehicle using a camera and providing a camera lane departure signal indicative thereof;
monitoring a vehicle rollover condition event of the vehicle using the camera and providing a camera rollover signal indicative thereof;
monitoring a rollover event of the vehicle using at least one machined type sensor and providing a machined sensor rollover signal indicative thereof; and
controlling actuation of an occupant restraining device in response to the camera lane departure signal, the camera rollover signal, and the machined sensor rollover signal.
